(19) United States
(12) Patent Application Publication
(10) Pub. No.: US 2011/0179808 A1
(43) Pub. Date: Jul. 28, 2011

(54) NECK DEICER FOR LIQUID HELIUM RECONDENSOR OF MAGNETIC RESONANCE SYSTEM

(75) Inventors: Alexander Kagan, Guilderland, NY (US); Chandra T. Reis, Altamont, NY (US)

(73) Assignee: KONINKLIJKE PHILIPS ELECTRONICS N.V., EINDHOVEN (NL)

(21) Appl. No.: 13/061,825

(22) PCT Filed: Sep. 9, 2009
(86) PCT No.: PCT/IB09/53949

§ 371 Date: Mar. 2, 2011

Related U.S. Application Data
(60) Provisional application No. 61/098,809, filed on Sep. 22, 2008.

(51) Int. Cl. F17C 6/00; F17C 13/10; F25D 21/06; F25D 21/08

(52) U.S. Cl. 62/48.2; 62/80; 62/275; 62/156

(57) ABSTRACT

A cryogenic system comprises: a liquid helium vessel containing liquid helium (LHe) in which are immersed superconducting magnet windings (20); a helium condenser (30); a neck (32) providing fluid communication between the liquid helium vessel and the helium condenser; a heater (42) disposed outside of and not surrounding the neck; and a thermally conductive passive deicing member (50) disposed in the neck, the thermally conductive passive deicing member thermally coupled with the heater to conduct heat from the heater into the neck. A deicing method for deicing a neck (32) of a liquid helium vessel of a superconducting magnet system comprises generating heat at a location (30, 42) outside of the neck and conducting an amount of the generated heat effective for deicing the neck from outside of the neck through an opening of the neck and into the neck to deice the neck.

The following relates to the magnetic resonance arts. It finds particular application in magnetic resonance systems employing superconducting magnets.

Magnetic resonance systems advantageously employ superconducting magnets in order to efficiently obtain a high magnetic field, for example a 1.5 Tesla field, a 3.0 Tesla field, a 7.0 Tesla field, or so forth. Superconducting magnets must be maintained at a temperature that is below the critical temperature for superconductivity at the electric current driving the operating superconducting magnet windings. As this temperature is typically below the ˜77K temperature at which nitrogen liquefies, it is known to employ liquid helium cooling for superconducting magnets.

In closed loop liquid helium cooling systems, a vacuum-jacketed helium vessel contains the superconducting magnet immersed in helium. The liquid helium slowly boils off. To implement a closed system, the helium vapor that boils off is recondensed into liquid helium by a recondensing surface maintained at sufficiently low temperature by a cold head. In some configurations, a two-stage cold head has a higher temperature stage (e.g., ˜35-40K) cooling an outside thermal shield surrounding the vacuum-jacketed helium vessel, and a lower temperature stage (e.g., 3.5K) at which helium recondenses.

A typical cold head includes a cryocooler motor with electrically conductive motor windings. The motor is preferably located at a lower magnetic field. The connection between the helium vessel and the recondensor should be designed to minimize heat transfer while allowing helium vapor to reach the recondensation surface and allowing condensed helium liquid to flow back into the liquid helium vessel. The operating cryocooler generates mechanical vibrations that should be isolated from the helium vessel. In one suitable design, the recondensation surface is connected with the helium vessel via a short, small-diameter flexible (e.g., bellowed) tube, typically of order 2-4 centimeters inner diameter.

The short, small-diameter flexible tube is known in the art as a neck. A problem arises in such designs in that impurities in the helium working fluid can condense onto the condenser or onto the neck. Most impurities, such as nitrogen, water vapor, and oxygen, have a freezing point that is much higher than the 4.2K freezing point of helium; accordingly, most impurities are prone to condense on the helium condensing surface. The neck is also cold enough for at least some types of impurities to condense onto the inside wall of the neck.

Typically, a service heater is disposed on or in the condenser, and the condenser surfaces are regenerated occasionally during servicing operations by heating the condenser surfaces using the service heater to drive off accumulated contaminants. The service heater can also be used to warm up the condenser surface preparatory to opening the system for service.

Addressing condensation of impurities in the small-diameter flexible neck is more problematic. One solution is to wrap heater windings around the neck, so that generated heat passes from the heater through the annular wall of the neck and to the condensed impurities within the neck. However, the neck is surrounded by a vacuum, which inhibits thermal coupling between the heater and the neck. It is also undesirable to incorporate components such as heater windings and electrical leads into the evacuated space. Still further, heating by operating heater windings disposed outside of the neck can liquefy or vaporize contaminants at the inside neck wall surface so as to detach the bulk of the contamination from the neck without completely vaporizing the contamination. The detached “ice ball” can then slide into the helium vessel, or onto the condenser, or to another undesirable place.

The following provides a new and improved apparatuses and methods which overcome the above-referenced problems and others.

In accordance with one disclosed aspect, a cryogenic system comprises: a liquid helium vessel containing liquid helium in which are immersed superconducting magnet windings; a helium condenser; a neck providing fluid communication between the liquid helium vessel and the helium condenser; a heater disposed outside of and not surrounding the neck; and a thermally conductive passive deicing member disposed in the neck, the thermally conductive passive deicing member thermally coupled with the heater to conduct heat from the heater into the neck.

In accordance with another disclosed aspect, a deicing method for deicing a neck of a liquid helium vessel of a superconducting magnet system comprises: generating heat at a location outside of the neck; and conducting an amount of the generated heat effective for deicing the neck from outside of the neck through an opening of the neck and into the neck to deice the neck.

In accordance with another disclosed aspect, a deicing system configured to deice a neck of a helium vessel containing superconducting magnet windings comprises: a heater disposed outside of and not surrounding the neck; and a thermally conductive passive deicing member disposed in the neck, the thermally conductive passive deicing member thermally coupled with the heater to conduct an amount of heat effective to deice the neck from the heater into the neck.

One advantage resides in enabling longer operational times between servicing of the liquid helium magnet cooling system.

Another advantage resides in simplifying servicing of the liquid helium magnet cooling system.

Further advantages will be apparent to those of ordinary skill in the art upon reading and understand the following detailed description.

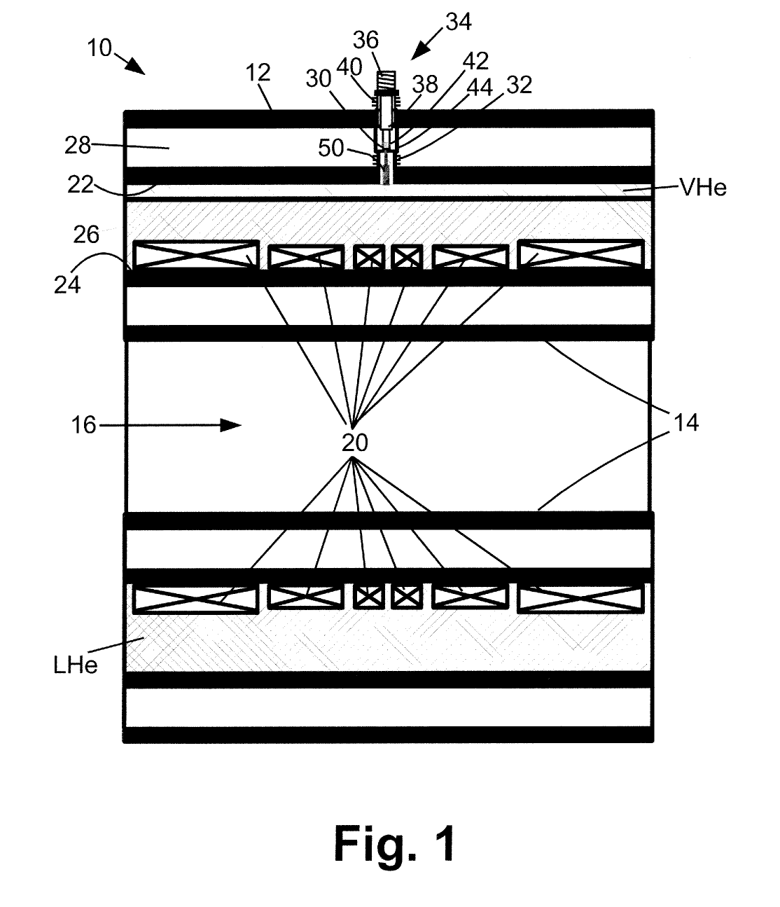

FIG. 1 diagrammatically shows a side sectional view of a magnetic resonance system including a helium vessel neck deicer.

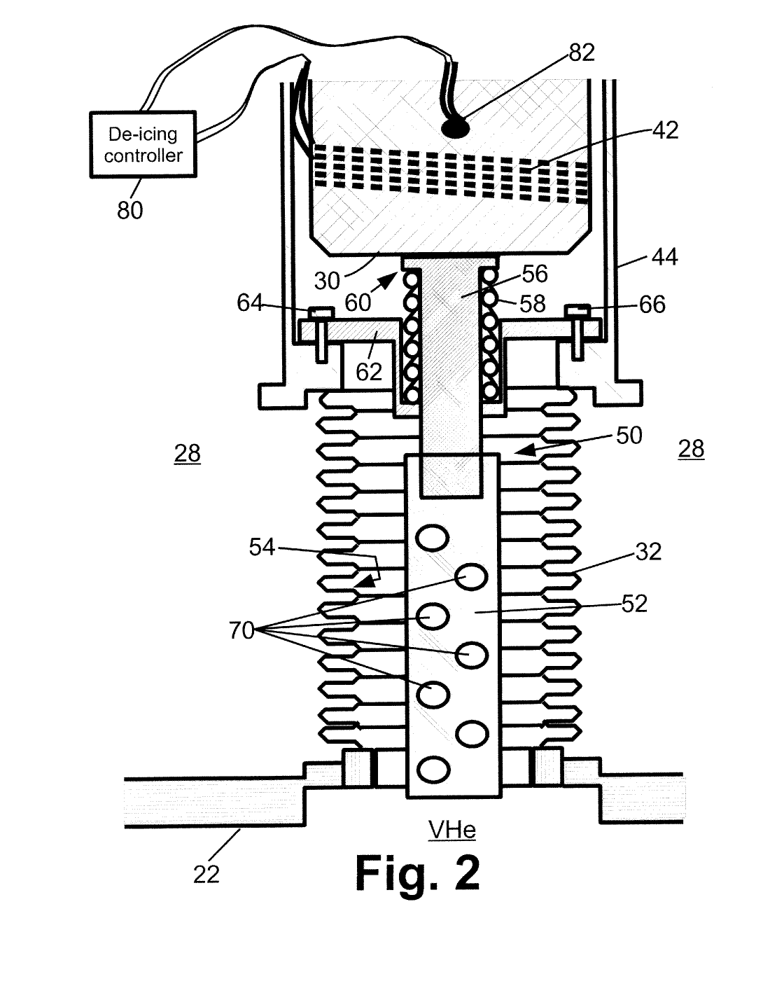

FIG. 2 diagrammatically shows an enlarged sectional view revealing details of the neck deicer of FIG. 1.

With reference to FIG. 1, an illustrative magnetic resonance system 10 is a horizontal-bore type system having an annular housing 12 with an inner cylindrical wall 14 surrounding and defining a generally cylindrical horizontally oriented bore 16. The illustrated horizontal-bore type system 10 is an example; the neck deicing systems and methods disclosed herein can generally be employed in any magnetic resonance system having superconducting magnet windings. The magnetic resonance system 10 includes superconducting magnet windings 20 arranged to generate a static (B₀) magnetic field oriented coaxially with the bore 16 at least in an examination region generally located at or near the center of the bore 16. Typically, the superconducting magnet windings 20 have a generally solenoidal configuration in which the windings 20 are wrapped coaxially around the bore 16; however, other configurations are contemplated, and additionally there may be provided active shim windings, passive steel shim, or so forth (additional components not shown). To keep the superconducting magnet windings 20 below a critical temperature for superconductivity at an electrical current effective to generate a desired static (B₀) magnetic field magnitude, the superconducting magnet windings 20 are immersed in liquid helium LHe that is disposed in a generally annular liquid helium vessel defined by an outer annular wall 22, an inner annular wall 24 and side walls 26. (Note, the walls 22, 24, 26 are labelled in FIG. 1 only at the upper left hand region). To provide thermal isolation, the outer wall 22 of the helium vessel is surrounded by a vacuum jacket 28.

Although not illustrated in diagrammatic FIG. 1, typically vacuum jacketing will be provided for the side walls 26 as well. Additional thermal isolation components, such as a surrounding liquid nitrogen jacket, are also contemplated but are not illustrated in diagrammatic FIG. 1. The magnetic resonance system 10 optionally further includes additional components such as a set of magnetic field gradient coils, which are typically disposed on one or more cylindrical dielectric formers disposed coaxially inside of the inner cylindrical wall 14; an optional whole-body cylindrical radio frequency coil which again is typically disposed on one or more cylindrical dielectric formers disposed coaxially inside of the inner cylindrical wall 14; an optional one or more local radio frequency coils or coil arrays such as a head coil, joint coil, torso coil, surface coil, array of surface coils, or so forth which are typically placed at strategic locations within the bore 16 so as to be proximate to a region of interest of a subject; or so forth. Other optional components not illustrated in FIG. 1 include electronics for operating the magnetic field gradient coils and radio frequency transmit coils, and data processing components for reconstructing a magnetic resonance image, performing magnetic resonance spectroscopy, or otherwise processing or analyzing acquired magnetic resonance data.

The liquid helium LHe is substantially thermally isolated by the walls 22, 24, 26 and surrounding vacuum jacket 28. However, imperfect thermal isolation together with other sources of heating generally lead to slow vaporization of the liquid helium LHe. This is diagrammatically shown in FIG. 1 by a region of vapour helium VHe that collects over the surface of the liquid helium LHe. By operation of gravity, the vapour helium VHe typically collects “above” the liquid helium LHe, as shown in FIG. 1. The superconducting magnet windings 20 are wrapped around the inner annular wall 24 of the helium vessel, and hence remain immersed in the liquid helium LHe in spite of formation of the upper layer of vapour helium VHe.

To provide a closed loop liquid helium cooling system, the vapour helium VHe is recondensed into liquid helium at a recondensation surface 30 that is outside of the liquid helium vessel but connected with the liquid helium vessel by a small-diameter orifice or “neck” 32. The recondensation surface 30 is kept at a temperature sufficiently low to promote condensation of vapour helium, for example kept at a temperature of below about 4.2K, and more preferably at or below about 3.5K, by operation of a cold head 34 driven by a cryocooler motor 36. Because the cryocooler motor 36 has electrically conductive motor windings, it is preferably disposed outside of the magnet space defined by the superconducting magnet windings 20. Optionally, the cold head 34 may include other condensation stages such as a second stage condensation surface 38 at about 77K or lower that provides condensation of liquid nitrogen, for example to support an outer liquid nitrogen jacket (not shown). To provide vibrational isolation, a mount 40 of the cryocooler motor 36 is optionally bellowed. Similarly, the neck 32 of the liquid helium vessel is bellowed in the illustrated embodiment to provide flexibility and vibrational isolation. In some embodiments, the neck 32 is a short, small-diameter flexible (for example, bellowed) tube of order 2-4 centimeters inner diameter, although larger or smaller inner diameter values are also contemplated.

In operation, the vapour helium VHe expands into the neck 32 to contact the recondensation surface 30, where the vapour liquefies to form condensed liquid helium. Because the recondensation surface 30 is positioned above the liquid helium vessel, the condensed liquid helium flows under the force of gravity back into the liquid helium vessel to contribute to the mass of liquid helium LHe. Alternatively or additionally, a wicking structure can be provided to transport the condensed liquid helium back to the mass of liquid helium LHe by capillary action, or by a combination of gravity and capillary action.

However, other impurities may condense out onto the recondensation surface 30. This condensation of impurities is referred to in the art as “ice”. As used herein, the term “ice” is intended to encompass any condensed impurity in the helium, including but not limited to: condensed nitrogen; condensed oxygen; condensed water vapour or frozen water; condensed carbon dioxide; and so forth. It is particularly noted that the term “ice” as used herein is not limited to liquid or frozen water vapour.

A service heater 42 is optionally disposed at or proximate to and in thermal communication with the recondensation surface 30. During servicing operations, the service heater 42 is suitably operated to heat the recondensation surface 30 in order to deice the recondensation surface. As used herein, the term “deice” refers to causing condensed impurities, that is, ice, to liquefy or vaporize so as to remove the ice.

In the illustrated embodiment, the recondensation assembly including at least the recondensation surfaces 30, 38 are enclosed in a sealed jacket or “wet sock” 44 that is sealed with the neck 32 to provide fluid isolation of the helium recondensation process from the surrounding ambient and from the volume of the vacuum jacket 28. The illustrated wet sock 44 is configured to facilitate removal of the cold head 34 for servicing without complete dismantling of the associated liquid helium recondensation port assembly. In other embodiments, other fluid isolation configurations may be used.

There is also some likelihood that ice may build up in the neck 32. This heat is not effectively removed by the service heater 42 operating by itself, because the pressure in the neck 32 and in vicinity thereto is too low to provide substantial convectional heat transfer. Additionally, there is no conductive heat transfer path between the service heater 42 and the inner wall of the neck 32. The service heater 42 is also too far away to provide radiative heating of the neck 32 operating by itself.

In the embodiment of FIG. 1, these deficiencies of the service heater 42 are overcome by providing a thermally conductive passive deicing member 50 disposed in the neck 32. The thermally conductive passive deicing member 50 is thermally coupled with the service heater 42 to conduct heat from the heater 42 to condensed matter (that is, ice) disposed in the neck 32. The thermally conductive passive deicing member 50 is thermally coupled with the service heater 42 to conduct an amount of heat effective to deice the neck 32 from the service heater 42 into the neck 32. As used herein, the term “passive” deicing element is intended to encompass any deicing element that does not conduct heater current and does not employ mechanical action to enhance deicing.

With continuing reference to FIG. 1 and with further reference to FIG. 2, the illustrative thermally conductive passive deicing member 50 is described in further detail. The illustrated thermally conductive passive deicing member 50 includes a thermally conductive heat radiating member 52 disposed in the neck 32 and configured to radiate heat toward an interior wall 54 of the neck 32, and a plunger 56 mechanically biased by a spring 58 against the heat source. In the illustrated embodiment the heat source comprises the recondensation surface 30 heated by the service heater 42. To ensure good thermal contact between the heat source and the thermally conductive passive deicing member 50, the spring 58 is held in compression between an upper extension or annular flange 60 of the plunger 56 and a “T”-shaped or annular anchoring member 62 secured to the wet sock 44 by bolts or other fasteners 64, 66. The illustrated compressive thermal coupling has advantages such as entailing no modification of the cold head 34 or the condensation surface 30, enabling removal of the cold head 34 for servicing without removal of the thermally conductive passive deicing member 50, mechanical simplicity, avoidance of volatile materials, and so forth. Other thermal coupling mechanisms are also contemplated, such as mechanically bolting or otherwise securing the thermally conductive passive deicing member with the condensation surface, or using an adhesive, although in latter embodiments the adhesive should be compatible with the cryogenic helium vessel environment, for example being substantially nonvolatile.

The illustrated thermally conductive heat radiating member 52 disposed in the neck 32 is generally tubular and arranged coaxially inside the tubular neck 32. This geometry provides a substantially uniform distance between the surface of the thermally conductive heat radiating member 52 and the proximate portion of the interior wall 54 of the neck 32, which enhances deicing efficiency and uniformity. However, other geometries for the thermally conductive heat radiating member are also contemplated. The illustrated thermally conductive heat radiating member 52 includes openings, vias, passages, or other fluid conduits 70 that reduce the impedance to flow of vaporous helium VHe from the helium vessel toward the recondensation surface 32. In some embodiments, the thermally conductive heat radiating member 52 is additionally or alternatively substantially hollow to reduce fluid flow impedance. The thermally conductive heat radiating member 52 can be made of any thermally conductive material that is compatible with the cryogenic helium vessel environment, such as copper, brass, molybdenum, or another metal, or a thermally conductive ceramic material. The selected material is preferably nonvolatile to mitigate or avoid introduction of impurities into the helium working fluid.

The plunger 56 is also suitably made of any thermally conductive material that is compatible with the cryogenic helium vessel environment, such as copper, brass, molybdenum, or another metal, or a thermally conductive ceramic material. The selected material is preferably nonvolatile to mitigate or avoid introduction of impurities into the helium working fluid. In some embodiments, a flowable or deformable thermally conductive interface material such as indium is contemplated to be interposed between the contacting flange 60 of the plunger 56 and the recondensation surface 32.

The connection between the thermally conductive heat radiating member 52 and the plunger 56 can employ any connection mechanism that is compatible with the cryogenic helium vessel environment, such as employing a bolt or other fastener or plurality of fasteners, or employing a friction fit, or so forth. In some embodiments the thermally conductive heat radiating member 52 and the plunger 56 may be integrally formed of a single piece. Again, a flowable or deformable thermally conductive interface material such as indium is contemplated to be interposed at the connection to enhance thermal communication between the components 52, 56.

The spring 58 can be made of any compressible material that is compatible with the cryogenic helium vessel environment. Although the illustrated spring 58 has a conventional helical “spring” shape, other spring geometries are also contemplated, such as a compressed annular cylinder geometry arranged coaxially with the plunger 56, or a Belleville washer or plurality of Belleville washers, or a compressible metallic foam or other compressible thermally conductive material, various combinations of the preceding, or so forth. The illustrated spring 58 can also be made of a thermally conductive material, in which case the spring 58 further contributes to the thermal conduction pathway. Alternatively, the illustrated spring 58 can be made of a thermally insulating material or a material of low thermal conductivity, in which case the spring 58 substantially does not contribute to the thermal conduction pathway.

Operation of the thermally conductive passive deicing member 50 is as follows. During normal operation of the superconducting magnet windings 20, the service heater 42 is off (that is, no electrical current flows through the heater 42), and the cold head 34 is operative to maintain the recondensation surface 30 at a temperature effective to recondense vaporous helium, for example at about 4.2K or lower, or more preferably at about 3.5K or lower. During normal magnet operation, the thermally conductive passive deicing member 50 is nonoperative, except to the extent that it may provide additional surface area at the temperature effective to recondense vaporous helium (and therefore effectively operate as additional recondensing surface area).

During normal magnet operation, impurities may condense on the recondensation surface 30 and on the interior wall 54 of the neck 32. Over time, these impurities may compromise the recondensation efficiency by changing the characteristics of the recondensation surface 30, or by impeding flow of vaporous helium to the recondensation surface 30.

Accordingly, at selected servicing occasions a deicing process may be performed. This process entails turning off the cold head 34 and operating the service heater 42 to raise the temperature of the recondensation surface 30 to deice the recondensation surface 30. Simultaneously with the deicing of the recondensation surface 30, some heat generated by the service heater 42 conducts down the thermally conductive plunger 56 and to the thermally conductive heat radiating member 52. This raises the temperature of the thermally conductive heat radiating member 52 and causes radiative heat to flow outward from the thermally conductive heat radiating member 52 toward the interior wall 54 of the neck 32. A de-icing controller 80 flows electrical current through the service heater 42 to generate heat, and the amount of heating is monitored by a thermocouple, temperature diode, or other temperature sensor 82 that is configured to measure a temperature indicative of a temperature of the thermally conductive passive deicing member 50. In the illustrated embodiment, the temperature sensor 82 is located proximate to the recondensation surface 30 to monitor the temperature of the recondensation surface 30. The temperature sensor 82 may, for example, be one conventionally included in a typical cold head for this purpose. The temperature monitored by the temperature sensor 82 is indicative of the temperature of the thermally conductive passive deicing member 50, since the temperature of the thermally conductive passive deicing member 50 is determined by the temperature of the heat source including the recondensation surface 30 and thermal resistance characteristics (or, equivalently, thermal conductance characteristics) of the thermally conductive passive deicing member 50. The de-icing controller 80 is further configured to operate and control the service heater 42 during deicing of the condensation surface 30 and the neck 32 based on temperature feedback provided by the temperature sensor 82, so as to conduct an amount of the generated heat effective for deicing the neck 32 from outside of the neck 32 (namely in the illustrated embodiment at the heat source comprising the service heater 42 and the condensation surface 30) through the opening of the neck 32 providing access to the condensation surface 30 and into the neck 32 to deice the neck 32. Advantageously, the heat radiates outward from the thermally conductive heat radiating member 52 toward the interior wall 54 of the neck 32, so that the condensation most distal from the interior wall 54 of the neck 32 is deiced first and the deicing process works toward the interior wall 54 of the neck 32.

This is to be contrasted with deicing performed using a heater wrapped around the exterior of the neck 32, in which case the deicing starts at the condensation directly contacting the interior wall 54 of the neck 32 and works outward toward the condensation most distal from the interior wall 54 of the neck 32. When deicing is performed using a heater wrapped around the exterior of the neck 32, there is a likelihood that the condensation may detach from the interior wall 54 of the neck 32 since the condensation directly contacting the interior wall 54 deices first, which can lead to a detached “ice ball” that can slide down into the helium vessel or into another undesirable location.

In contrast, the thermally conductive heat radiating member 52 radiates heat outward toward the interior wall 54 of the neck 32, so that the condensation most distal from the interior wall 54 of the neck 32 is deiced first. This substantially reduces the likelihood that a detached “ice ball” will be generated, since the condensation directly contacting the interior wall 54 and hence retaining the condensation against the interior wall 54 is the last portion removed by the deicing process employing the thermally conductive heat radiating member 52.

The illustrated thermally conductive passive deicing member 50 is an example, and numerous variant embodiments are contemplated. For example, the spring 58 can be replaced by a spring compressed between the heat source (e.g., the condensation surface 30) and the thermally conductive passive deicing member. In this embodiment, the spring should be thermally conductive as it is a primary component of the thermal pathway from the heat source to the thermally conductive passive deicing member. In some such embodiments, the plunger may be omitted entirely. In other embodiments, the spring is contemplated to be disposed between the plunger and the thermally conductive heat radiating member to indirectly compress the plunger against the heat source and additionally provide compressive thermal contact between the plunger and the thermally conductive heat radiating member via the spring, which again in this embodiment is a thermally conductive spring. It is also contemplated to use an arrangement in which the spring is in tension, for example having one end of the spring attached to an anchor point at or above the condensation surface 30 and the other end attached to the thermally conductive passive deicing member and in tensile strain so as to “pull” the thermally conductive passive deicing member against the condensation surface 30.

In the illustrated embodiment, the service heater 42 of the cold head 34 generates heat, an amount of which generated heat effective for deicing the neck 32 conducts from outside of the neck 32 through an opening of the neck 32 via the plunger 56 and into the thermally conductive heat radiating member 52 in the neck 32 to deice the neck 32. This arrangement advantageously leverages the existing service heater 42 of the cold head 34 to additionally deice the neck. However, it is also contemplated to provide a separate heater disposed outside of the neck 32 for generating heat that conducts to the thermally conductive heat radiating member 52 in the neck 32 to deice the neck 32. For example, the neck to be deiced may be other than the neck providing fluid communication with a helium recondensing system. As an illustrative example, the neck to be deiced may be a safety vent neck to provide emergency release of vaporizing helium in the event of catastrophic loss of thermal isolation of the helium vessel. In such a case, the thermally conductive passive deicing member suitably extends from a point outside of the neck and into the neck, and is secured to a suitable anchor point located outside of the neck and outside of the helium vessel. The heater is then suitably wrapped around the portion of the thermally conductive passive deicing member extending outside of the neck and outside of the helium vessel. Optionally, a control thermocouple or other control heat sensor is mounted on the portion of the thermally conductive passive deicing member extending outside of the neck and outside of the helium vessel to enable feedback control of the deicing process. In these embodiments, since the heater is in direct thermal contact with the thermally conductive passive deicing member there is no need for spring biasing or another thermal connection enhancement, although the use of compressible conductive foam, indium, or the like disposed between the heater windings and the thermally conductive passive deicing member is contemplated.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A cryogenic system comprising:
a liquid helium vessel containing liquid helium in which are immersed superconducting magnet windings;
a helium condenser;
a neck providing fluid communication between the liquid helium vessel and the helium condenser;
a heater disposed outside of and not surrounding the neck; and
a thermally conductive passive deicing member disposed in the neck, the thermally conductive passive deicing member thermally coupled with the heater to conduct heat from the heater into the neck.

2. The cryogenic system as set forth in claim 1, wherein the neck is tubular, and the thermally conductive passive deicing member comprises:
a thermally conductive generally tubular heat radiating member arranged substantially coaxially inside the tubular neck.

3. The cryogenic system as set forth in claim 2, wherein the thermally conductive generally tubular passive deicing member defines openings or paths for vaporous helium flow through the thermally conductive tubular passive deicing member.

4. The cryogenic system as set forth in claim 1, further comprising:
a spring mechanically biasing the thermally conductive passive deicing member against a heat source including the heater in order to enhance thermal coupling between the thermally conductive passive deicing member and the heater.

5. The cryogenic system as set forth in claim 4, wherein the thermally conductive passive deicing member comprises:
a thermally conductive heat radiating member disposed in the neck and configured to radiate heat toward an interior wall of the neck; and
a plunger biased by the spring against the heat source.

6. The cryogenic system as set forth in claim 1, further comprising:
a temperature sensor configured to measure a temperature indicative of a temperature of the thermally conductive passive deicing member; and
a controller configured to control the heater during deicing of the neck based on temperature feedback provided by the temperature sensor.

7. The cryogenic system as set forth in claim 1, wherein the thermally conductive passive deicing member includes at least one component that is made of copper.

8. The cryogenic system as set forth in claim 1, further comprising:
a cold head arranged to maintain the helium condenser at a temperature effective for helium condensation at the helium condenser.

9. The cryogenic system as set forth in claim 8, wherein the heater is a service heater of the cold head.

10. The cryogenic system as set forth in claim 1, further comprising:
said superconducting magnet windings.

11. A deicing method for deicing a neck of a liquid helium vessel of a superconducting magnet system, the deicing method comprising:
generating heat at a location outside of the neck; and
conducting an amount of the generated heat effective for deicing the neck from outside of the neck through an opening of the neck and into the neck to deice the neck.

12. The deicing method as set forth in claim 11, wherein an amount of heat effective for deicing the neck does not pass from outside the neck through any wall of the neck into the neck.

13. The deicing method as set forth in either claim 11, wherein the conducting comprises:
providing a heat conductive pathway extending from the location outside the neck at which said heat is generated through the opening of the neck and into the neck to deice the neck.

14. The deicing method as set forth in claim 13, wherein the conducting further comprises:
mechanically biasing an end of the heat conductive pathway proximate to said location outside the neck at which said heat is generated against said location outside the neck at which said heat is generated.

15. The deicing method as set forth in either claim 11, wherein said location outside the neck at which said heat is generated includes a recondenser stage of a cold head arranged to recondense gaseous helium into liquid helium that flows through the neck into the liquid helium vessel, and the generating heat comprises:
operating a service heater of the cold head.

16. A deicing system configured to deice a neck of a helium vessel containing superconducting magnet windings, the deicing system comprising:
a heater disposed outside of and not surrounding the neck; and
a thermally conductive passive deicing member disposed in the neck, the thermally conductive passive deicing member thermally coupled with the heater to conduct an amount of heat effective to deice the neck from the heater into the neck.

17. The deicing system as set forth in claim 16, wherein the neck is tubular, and the thermally conductive passive deicing member includes a generally tubular portion arranged coaxially inside the neck.

18. The deicing system as set forth in either claim 16, wherein the thermally conductive passive deicing member comprises:
a thermally conductive heat radiating member disposed in the neck and configured to radiate heat toward an interior wall of the neck.

19. The deicing system as set forth in claim 16, further comprising:
a temperature sensor configured to measure a temperature indicative of a temperature of the thermally conductive passive deicing member; and
a controller configured to control the heater during deicing of the neck based on temperature feedback provided by the temperature sensor.

20. The deicing system as set forth in claim 16, wherein the heater comprises:
a service heater of a recondensation system arranged to recondense gaseous helium into liquid helium that flows through the neck into the liquid helium vessel.
